(19) United States
(12) Patent Application Publication
(10) Pub. No.: US 2016/0097297 A1
(43) Pub. Date: Apr. 7, 2016

(54) COMPRESSOR AND TURBOCHARGER

(71) Applicant: Cummins Ltd., Huddersfield (GB)

(72) Inventors: Thurstan Twist, Huddersfield (GB); Clive R. Martin, Huddersfield (GB)

(21) Appl. No.: 14/877,076

(22) Filed: Oct. 7, 2015

(30) Foreign Application Priority Data
Oct. 7, 2014 (GB) 1417744.8

(51) Int. Cl. F01D 15/08; F04D 25/04; F04D 29/053; F04D 29/056; F01D 25/16; F04D 29/44; F04D 29/42; F01D 5/02; F01D 9/02; F01D 25/24; F04D 17/10; F04D 29/28

(52) U.S. Cl. CPC F01D 15/08; F04D 17/10; F04D 25/04; F04D 29/053; F04D 29/056; F04D 29/284; F04D 29/441; F04D 29/4206; F01D 5/02; F01D 9/02; F01D 25/24; F01D 25/162; F05D 2220/40; F05D 2240/24; F05D 2240/12

(57) ABSTRACT

A compressor comprising a housing having an axial intake and an annular outlet volute, an impeller mounted for rotation about a shaft axis, the impeller having a plurality of blades, an annular diffuser passage surrounding the impeller extending from a diffuser inlet to a diffuser outlet, the impeller hub being mounted in an annular impeller recess in a first wall member of the diffuser, wherein an annular diffuser recess is provided in the first wall member extending radially outwardly from a first end to a second end, the first end being located at a radially outer end of the impeller recess, the second end being located axially inboard of the first end of the diffuser recess and wherein the depth of the diffuser recess at the first end of the diffuser recess is at least 30% of the maximum depth of the impeller recess.

### RELATED APPLICATIONS

The present disclosure claims priority to United Kingdom Application S/N GB 1417744.8, filed on Oct. 7, 2014, entitled “Compressor and Turbocharger,” the entire contents of which being expressly incorporated herein by reference.

### FIELD OF THE DISCLOSURE

The present disclosure relates to a compressor, particularly but not exclusively, a compressor for use in a turbocharger, such as a variable geometry turbocharger. The present disclosure also relates to a turbocharger and to a method of use of a turbocharger.

### BACKGROUND

A compressor comprises an impeller wheel, carrying a plurality of blades (or vanes) mounted on a shaft for rotation within a compressor housing. Rotation of the impeller wheel causes gas (e.g., air) to be drawn into the impeller wheel and delivered to an outlet chamber or passage.

Turbochargers are well known devices for supplying air to the intake of an internal combustion engine at pressures above atmospheric pressure (boost pressures). A conventional turbocharger essentially comprises a housing in which is provided an exhaust gas driven turbine wheel mounted on a rotatable shaft connected downstream of an engine outlet manifold. A compressor impeller wheel is mounted on the opposite end of the shaft such that rotation of the turbine wheel drives rotation of the impeller wheel. In this application of a compressor, the impeller wheel delivers compressed air to the engine intake manifold. The turbocharger shaft is conventionally supported by journal and thrust bearings, including appropriate lubricating systems.

In known turbochargers, the turbine stage comprises a turbine chamber within which the turbine wheel is mounted, an annular inlet passage defined between facing radial walls arranged around the turbine chamber, an inlet arranged around the inlet passage, and an outlet passage extending from the turbine chamber. The passages and chambers communicate such that pressurised exhaust emissions, including gaseous and particulate species, admitted to the inlet chamber flow through the inlet passage to the outlet passage via the turbine and rotate the turbine wheel. It is also known to improve turbine performance by providing vanes, referred to as nozzle vanes, in the inlet passage so as to deflect gas flowing through the inlet passage towards the direction of rotation of the turbine wheel. Turbines may be of a fixed or variable geometry type. Variable geometry turbines differ from fixed geometry turbines in that the size of the inlet passage can be varied to optimise gas flow velocities over a range of mass flow rates so that the power output of the turbine can be varied to suit varying engine demands. For instance, when the volume of exhaust gas being delivered to the turbine is relatively low, the velocity of the gas reaching the turbine wheel is maintained at a level which ensures efficient turbine operation by reducing the size of the annular inlet passage.

A conventional centrifugal compressor comprises a housing having an axial intake and an annular outlet volute and an impeller mounted on a shaft for rotation about a shaft axis between the axial intake and the annular outlet volute.

An annular diffuser passage surrounds the impeller, the diffuser passage extending along a diffuser passage axis from a diffuser inlet downstream of the impeller to a diffuser outlet communicating with the annular outlet volute.

The impeller has a plurality of blades extending from a root, attached to a front surface of a hub of the impeller, to a tip. Each blade has a leading edge which, in use, rotates within the axial intake and a trailing edge which sweeps across the diffuser passage inlet. The tip of each blade is curved and extends from the leading edge to the trailing edge of the blade. In use, the tips of the impeller blades sweep across an intermediate surface of the compressor housing defined between the axial intake and the diffuser passage. The intermediate surface of the compressor housing has a curved shape that is complementary to the curved tips of the blades.

The diffuser passage is defined by first and second opposed surfaces of first and second walls of the compressor housing respectively. The first surface is provided on the same axial side of the diffuser passage as the impeller wheel hub and the second surface is provided on the opposite axial side of the diffuser passage to the impeller wheel hub. In this regard, the second surface of the diffuser passage is provided on the same axial side of the diffuser passage as the intermediate surface of the compressor housing, and is an extension of the intermediate surface.

The impeller hub is mounted within an annular impeller recess in the first wall of the compressor housing.

In use, it is preferable that the front surface of the hub is located axially inboard of the first surface of the diffuser passage (inboard in relation to the diffuser passage axis). Specifically, it is preferable that the front surface of the hub is located axially inboard of the radially outer end of the impeller wheel recess. This is advantageous in that it reduces losses in the flow through the diffuser passage.

In contrast, if the front surface of the hub is axially outboard of the radially outer end of the impeller wheel recess, this can result in flow exiting the front surface of the impeller hub to be disturbed as it “trips off” the radially outer edge of the impeller recess inboard of the impeller deck, resulting in increased turbulence and loss of performance, as well as communicating higher static pressures behind the impeller wheel, which in turn increases the thrust load on the compressor. This also increases the blow past gases past seals on the compressor wheel, in to the bearing system and engine crankcase.

In the manufacture of an impeller wheel, there are a number of components that contribute to the stack up of tolerances that determine the axial position of the front surface of the hub relative to the radially outer end of the impeller wheel recess. This is problematic in that, when the compressor is manufactured, there is a relatively wide variation in the axial position of the front surface of the hub relative to the radially outer end of the impeller wheel recess.

In this regard, a proportion of manufactured compressors may have a front surface of the hub that is axially outboard of the radially outer end of the impeller wheel recess, and a proportion may have an impeller wheel located such that the front surface of its hub is axially inboard of the radially outer end of the impeller wheel recess.

Furthermore, in use the impeller wheel may move axially. Such axial movement occurs due to the free floating nature of the bearing system and due to the net axial forces imparted on the impeller wheel. Accordingly, during use, compressors may have an impeller wheel located such that the front surface of its hub switches from axially outboard of, to axially inboard of the radially outer end of the impeller wheel recess, on an intermittent basis, resulting in the above mentioned problems.

### SUMMARY

It is an object of the present disclosure to obviate or mitigate one or more of the problems set out above.

A further object of the present disclosure is to provide an improved or alternative compressor. A yet further object of the present disclosure is to provide a compressor exhibiting improved compressor stage efficiency.

According to a first aspect of the present disclosure there is provided a compressor comprising:

a housing having an axial intake and an annular outlet volute;

an impeller mounted on a shaft for rotation about a shaft axis between the axial intake and the annular outlet volute;

the impeller having a plurality of blades extending from a root to a tip, the roots of the blades being attached to a front surface of a hub of the impeller;

an annular diffuser passage surrounding the impeller, the diffuser passage extending along a diffuser passage axis from a diffuser inlet downstream of said plurality of blades to a diffuser outlet communicating with the annular outlet volute;

the diffuser passage being defined by first and second diffuser surfaces of first and second wall members respectively;

the impeller hub being mounted in an annular impeller recess in the first wall member;

wherein an annular diffuser recess is provided in the first wall member, the diffuser recess extending radially outwardly from a first end to a second end, the first end being located at a radially outer end of the impeller recess, the second end being located axially inboard of the first end of the diffuser recess; and

wherein the depth of the diffuser recess at the first end of the diffuser recess is at least 30% of the maximum depth of the impeller recess.

In this embodiment, if the impeller wheel moves axially in use, due to the net axial forces imparted on the impeller wheel, the radially outer end of the front surface of the hub of the impeller may be located substantially axially in-line with, or inboard of, the first end of the diffuser recess, at each axial position of the impeller wheel.

Alternatively, or additionally, the axial position of the impeller wheel may also vary due to the manufacturing tolerances of one or more components of the compressor. The above arrangement may allow components of the compressor to have manufacturing tolerances such that, at any axial position of the manufactured impeller wheel, due to the tolerances of the set of components of the compressor, the radially outer end of the front surface of the hub of the impeller is located substantially axially in-line with, or inboard of, the first end of the diffuser recess. This may reduce losses in the flow through the diffuser passage.

Furthermore, the shape of the diffuser recess may smoothly guide the flow from the impeller wheel to the diffuser passage, thereby reducing losses in the flow.

The compressor may be arranged such that, in use, the axial position of the impeller wheel varies. Alternatively, the compressor may be arranged such that, in use, the axial position of the impeller wheel is substantially fixed.

It will be appreciated that references to axial depth refer to the axial distance from the second end of the diffuser recess.

It will be appreciated that references to axially inboard and outboard refer to the axial direction (the direction of the shaft axis) towards and away from the diffuser passage axis respectively. Furthermore, it will be appreciated that references to radial and circumferential refer to the radial and circumferential directions (or positions) relative to the shaft axis.

The depth of the diffuser recess at the first end of the diffuser recess may be greater than 30% of the maximum depth of the impeller recess. The depth of the diffuser recess at the first end of the diffuser recess may be greater than or equal to 40% of the maximum depth of the impeller recess. The depth of the diffuser recess at the first end of the diffuser recess may be greater than or equal to 50% of the maximum depth of the impeller recess.

The depth of the diffuser recess at the first end of the diffuser recess may be in the range 35% to 75% of the maximum depth of the impeller recess. The depth of the diffuser recess at the first end of the diffuser recess may be in the range 35% to 60% of the maximum depth of the impeller recess.

The first end of the diffuser recess may be located substantially axially in line with, or axially inboard of, a rear surface of the impeller hub.

The cross-sectional area of the diffuser passage, about the diffuser passage axis, may decrease from the diffuser inlet to the radial location at which the cross-sectional area of the diffuser passage is a minimum.

The second end of the diffuser recess may be located substantially radially in-line with, or radially inwardly of, the radial location of the minimum cross-sectional area of the diffuser passage. Preferably the second end of the recess is located radially inwardly of the minimum cross-sectional area of the diffuser passage.

The second end of the diffuser recess may be located at a radius in the range 70% to 100% of the radius of the radial location at which the cross-sectional area of the diffuser passage is a minimum. The second end of the diffuser recess may be located at a radius in the range 73% to 90% of the radius of the radial location at which the cross-sectional area of the diffuser passage is a minimum.

The first end of the diffuser recess may be located at a radius in the range 60% to 99% of the radius of the radial location at which the cross-sectional area of the diffuser passage is a minimum. The first end of the diffuser recess may be located at a radius in the range 76% to 99% of the radius of the radial location at which the cross-sectional area of the diffuser passage is a minimum.

Optionally, the first diffuser surface comprises a first section that defines the diffuser recess, the first section extending radially outwardly from a first end at the first end of the diffuser recess, to a second end at the second end of the diffuser recess and a second section that extends radially outwardly from a first end, at the second end of the diffuser recess, to a second end, wherein the first and second sections are inclined relative to each other.

It will be appreciated that, in this case, references to axial depth refer to the axial distance from the first end of the second section of the first diffuser surface.

In this respect, at each circumferential location of the first section of the first diffuser surface, in the axial plane, the first and second sections may be inclined relative to each other. The second section may be inclined relative to the first section at least part way along the radial length of the second section.

It will be appreciated that the ‘axial plane’ at a circumferential location refers to a plane defined by the axial direction and by the radial direction at that circumferential location. In this regard, the shaft axis and the radial axis (the axis in the radial direction, at that circumferential location) are substantially contained within the axial plane. The shaft axis and the radial axis are substantially parallel to the axial plane. The axial plane passes through the shaft axis.

The first section of the first diffuser surface may be inclined relative to the second section of the first diffuser surface at an angle such that two supplementary angles are formed between the first section and the second section, a first acute angle and second obtuse angle, wherein the first angle is in the range 1° to 44.9°, preferably in the range 1° to 44°, more preferably in the range 1° to 40°.

In this regard, at each circumferential location of the first section of the first diffuser surface, in the axial plane, the first section of the first diffuser surface may be substantially straight and inclined relative to the second section of the first diffuser surface at an angle such that two supplementary angles are formed between the first section and the second section, a first acute angle and second obtuse angle, wherein the first angle is in the range 1° to 44.9°, preferably in the range 1° to 44°, more preferably in the range 1° to 40°.

The first section may be curved, or part-curved along its radial length. The first section may form a convex and/or a concave curve, from its first end to its second end.

The second end of the second section may be provided at the diffuser outlet. Alternatively, the second end of the second section may be provided radially inwardly of the diffuser outlet.

The first and second sections may be annular. The first and second sections may be formed by at least a circumferential portion of the first diffuser surface. The first and second sections may be formed by substantially the entire circumferential extent of the first diffuser surface. The first and second sections may have a substantially constant shape in the axial plane, with circumferential position.

The second section of the first diffuser surface may be substantially planar. In this regard, at each circumferential location of the second section of the first diffuser surface, in the axial plane, the second section may be substantially straight. The second section of the first diffuser surface may be substantially parallel to the diffuser passage axis.

The first section of the first diffuser surface may comprise first and second portions, the first portion extending radially outwardly from a first end, at the first end of the first section, to a second end and the second portion extending radially outwardly from a first end, at the second end of the first portion, to a second end at the second end of the first section.

The first and second portions may be inclined relative to each other. In this respect, at each circumferential location of the first section of the first diffuser surface, in the axial plane, the first and second portions may be inclined relative to each other. The second portion may be inclined relative to the first portion at least part way along the radial length of the second portion.

The second portion may be inclined relative to the second section of the first diffuser surface. In this respect, at each circumferential location of the first section of the first diffuser surface, in the axial plane, the second portion may be substantially straight and inclined relative to the second section of the first diffuser surface. The second portion may be inclined relative to the second section of the first diffuser surface at an angle such that two supplementary angles are formed between the second portion and the second section, a first acute angle and second obtuse angle, wherein the first angle is in the range 1° to 44.9°, preferably in the range 1° to 44°, more preferably in the range 1° to 40°.

The first and/or second portions may be at least part curved along its radial length. In this respect, at each circumferential location of the first section of the first diffuser surface, in the axial plane, the first and/or second portion may be curved, or part curved. The curve may be a concave and/or a convex curve. The curve may be an S-shape. In this regard, the second portion may have a radially inner section that forms a concave curve and a radially outer section that forms a convex curve.

At each circumferential location of the first section, in the axial plane, the second portion may curve from its first end to its second end in the axially inboard direction.

At the second end of the first portion, the second portion may be inclined relative to the first portion at an angle such that two supplementary angles are formed between the first and second portions, a first acute angle and second obtuse angle, wherein the first angle is less than 40°.

Optionally, the second portion may comprise a plurality of sections that are inclined relative to each other. In this regard, at each circumferential location of the first section of the first diffuser surface, the plurality of sections may be inclined relative to each other in the axial plane. The plurality of sections may approximate a curve. The curve may be a concave curve. The curve may be an S-shape. In this regard, the second portion may have a radially inner section that forms a concave curve and a radially outer section that forms a convex curve.

The first portion may be substantially planar. In this respect, at each circumferential location of the first section of the first diffuser surface, the first portion may be substantially straight in the axial plane. The first portion may be substantially parallel to the second section of the first diffuser surface. Alternatively, the first portion may be inclined relative to the second section of the first diffuser surface. The first portion may be curved, or part curved. The first portion may form a concave curve.

The first and second portions may be formed by at least a circumferential portion of the first section of the first diffuser surface. The first and second portions may be formed by substantially the entire circumferential extent of the first section of the first diffuser surface. The first and second portions may have a substantially constant shape with circumferential position.

The diffuser recess may have a cross sectional shape that is substantially constant with circumferential position. The impeller recess may have a cross sectional shape that is substantially constant with circumferential position.

According to a second aspect of the present disclosure there is provided a compressor comprising:

a housing having an axial intake and an annular outlet volute;

an impeller mounted on a shaft for rotation about a shaft axis between the axial intake and the annular outlet volute;

the impeller having a plurality of blades extending from a root to a tip, the roots of the blades being attached to a front surface of a hub of the impeller;

an annular diffuser passage surrounding the impeller, the diffuser passage extending along a diffuser passage axis from a diffuser inlet downstream of said plurality of blades to a diffuser outlet communicating with the annular outlet volute;

the diffuser passage being defined by first and second diffuser surfaces of first and second wall members respectively;

the impeller hub being mounted in an annular impeller recess in the first wall member;

wherein an annular diffuser recess is provided in the first wall member, the diffuser recess extending radially outwardly from a first end to a second end, the first end being located at a radially outer end of the impeller recess, the second end being located axially inboard of the first end of the diffuser recess;

the first diffuser surface comprises a first section that defines the diffuser recess, the first section extending radially outwardly from a first end at the first end of the diffuser recess, to a second end at the second end of the diffuser recess and a second section that extends radially outwardly from a first end, at the second end of the diffuser recess, to a second end;

wherein the first section of the first diffuser surface is inclined relative to the second section of the first diffuser surface at an angle such that two supplementary angles are formed between the first section and the second section, a first acute angle and second obtuse angle, wherein the first angle is in the range 1° to 44.9°.

In this embodiment, the shape of the diffuser recess may smoothly guide the flow from the impeller wheel to the diffuser passage, thereby reducing losses in the flow.

In addition, if the impeller wheel moves axially in use, due to the net axial forces imparted on the impeller wheel, the front surface of the hub of the impeller may be located substantially axially in-line with, or inboard of, the first end of the diffuser recess, at each axial position of the impeller wheel.

Alternatively, or additionally, the axial position of the impeller wheel may also vary due to the manufacturing tolerances of one or more components of the compressor. The above arrangement may allow components of the compressor to have manufacturing tolerances such that, at any axial position of the manufactured impeller wheel, due to the tolerances of the set of components of the compressor, the radially outer end of the front surface of the hub of the impeller is located substantially axially in-line with, or inboard of, the first end of the diffuser recess. This may reduce losses in the flow through the diffuser passage.

In this respect, at each circumferential location of the first section of the first diffuser surface, in the axial plane, the first section of the first diffuser surface may be substantially straight and inclined relative to the second section of the first diffuser surface at an angle such that two supplementary angles are formed between the first section and the second section, a first acute angle and second obtuse angle, wherein the first angle is in the range 1° to 44.9°.

Optionally the first angle is in the range 1° to 44°, more preferably in the range 1° to 40°.

The depth of the diffuser recess at the first end of the diffuser recess may be in the range 1% to 99% of the maximum depth of the impeller recess. The depth of the diffuser recess at the first end of the diffuser recess may be in the range 5% to 75% of the maximum depth of the impeller recess.

The depth of the diffuser recess at the first end of the diffuser recess may be at least 30% of the maximum depth of the impeller recess.

According to a third aspect of the present disclosure there is provided a compressor comprising:

a housing having an axial intake and an annular outlet volute;

an impeller mounted on a shaft for rotation about a shaft axis between the axial intake and the annular outlet volute;

the impeller having a plurality of blades extending from a root to a tip, the roots of the blades being attached to a front surface of a hub of the impeller;

an annular diffuser passage surrounding the impeller, the diffuser passage extending along a diffuser passage axis from a diffuser inlet downstream of said plurality of blades to a diffuser outlet communicating with the annular outlet volute;

the diffuser passage being defined by first and second diffuser surfaces of first and second wall members respectively;

the impeller hub being mounted in an annular impeller recess in the first wall member;

wherein an annular diffuser recess is provided in the first wall member, the diffuser recess extending radially outwardly from a first end to a second end, the first end being located at a radially outer end of the impeller recess, the second end being located axially inboard of the first end of the diffuser recess;

the first diffuser surface comprises a first section that defines the diffuser recess, the first section extending radially outwardly from a first end at the first end of the diffuser recess, to a second end at the second end of the diffuser recess and a second section that extends radially outwardly from a first end, at the second end of the diffuser recess, to a second end;

the first section of the first diffuser surface comprising first and second portions, the first portion extending radially outwardly from a first end, at the first end of the first section, to a second end and the second portion extending radially outwardly from a first end, at the second end of the first portion, to a second end at the second end of the first section;

wherein the first and second portions are inclined relative to each other.

In this embodiment, the shape of the diffuser recess may smoothly guide the flow from the impeller wheel to the diffuser passage, thereby reducing losses in the flow.

In addition, if the impeller wheel moves axially in use, due to the net axial forces imparted on the impeller wheel, the front surface of the hub of the impeller may be located substantially axially in-line with, or inboard of, the first end of the diffuser recess, at each axial position of the impeller wheel.

Alternatively, or additionally, the axial position of the impeller wheel may also vary due to the manufacturing tolerances of one or more components of the compressor. The above arrangement may allow components of the compressor to have manufacturing tolerances such that, at any axial position of the manufactured impeller wheel, due to the tolerances of the set of components of the compressor, the front surface of the hub of the impeller is located substantially axially in-line with, or inboard of, the first end of the diffuser recess. This may reduce losses in the flow through the diffuser passage.

In this respect, at each circumferential location of the first section of the first diffuser surface, in the axial plane, the first and second sections may be inclined relative to each other.

The depth of the diffuser recess at the first end of the diffuser recess may be in the range 1% to 99% of the maximum depth of the impeller recess. The depth of the diffuser recess at the first end of the diffuser recess may be in the range 5% to 75% of the maximum depth of the impeller recess.

The depth of the diffuser recess at the first end of the diffuser recess may be at least 30% of the maximum depth of the impeller recess.

According to a fourth aspect of the disclosure there is provided a turbocharger comprising a compressor according to any of the preceding aspects of the disclosure and a turbine wheel coupled to said shaft so as to drivably rotate the impeller.

According to a fifth aspect of the present disclosure there is provided a turbocharger comprising a compressor and turbine;

the compressor comprising:

a housing having an axial intake and an annular outlet volute;

an impeller mounted on a shaft for rotation about a shaft axis between the axial intake and the annular outlet volute;

the impeller having a plurality of blades extending from a root to a tip, the roots of the blades being attached to a front surface of a hub of the impeller;

an annular diffuser passage surrounding the impeller, the diffuser passage extending along a diffuser passage axis from a diffuser inlet downstream of said plurality of blades to a diffuser outlet communicating with the annular outlet volute;

the diffuser passage being defined by first and second diffuser surfaces of first and second wall members respectively;

the impeller hub being mounted in an annular impeller recess in the first wall member;

the turbine comprising a turbine housing defining an inlet and an outlet, with a turbine wheel rotatably mounted within a chamber disposed between the inlet and outlet, the turbine wheel being drivably coupled to the impeller wheel by the shaft, the shaft being rotatably supported by a bearing assembly;

the turbocharger comprising a set of components, each component having a manufacturing tolerance such that in the manufactured turbocharger, the component has a physical dimension that may vary from a first value to a second value, when the physical dimension of the component is at the first value the radially outer end of the front surface of the impeller hub is caused to be located axially inboard of when the physical dimension of the component is at the second value;

wherein when the physical dimension of each component in the set of components is at the first value, the radially outer end of the front surface of the hub is located at a first axial position and when the physical dimension of each component in the set of components is at the second value, the radially outer end of the front surface of the hub is located at a second axial position, the first axial position being located axially inboard of the second axial position;

an annular diffuser recess is provided in the first wall member, the diffuser recess extending radially outwardly from first end to a second end, the first end being located at a radially outer end of the impeller recess, the second end being located axially inboard of the first end of the diffuser recess; and

wherein the depth of the diffuser recess at the first end of the diffuser recess is such that when the radially outer end of the front surface of the hub is at, or between, the first and second axial positions, the radially outer end of the front surface of the hub is located substantially axially in-line with, or inboard of, the first end of the diffuser recess.

In this embodiment, at different axial positions of the manufactured impeller wheel, due to the tolerances of the set of components of the turbocharger, the radially outer end of the front surface of the hub of the impeller is located substantially axially in-line with, or inboard of, the first end of the diffuser recess.

This ensures consistent performance of the compressor, since it is not the case that, due to the manufacturing tolerances, the radially outer end of the front surface of the hub of the impeller is sometimes outboard of the first end of the diffuser recess.

The hub may be substantially annular.

The second end of the recess may be axially located such that when the radially outer end of the hub is at, or between, the first and second axial positions, it is located axially outboard of, or substantially in-line with, the second end of the diffuser recess. Alternatively, the second end of the diffuser recess may be axially located such that when the radially outer end of the front surface of the hub is at, or between, the first and second axial positions, it is located axially inboard of the second end of the diffuser recess.

The set of components of the turbocharger may comprise the impeller wheel and/or the bearing assembly. The turbocharger may comprise an oil slinger mounted on the shaft to direct lubricating fluid away from the shaft. In this case, the set of components may comprise the oil slinger. The turbocharger may comprise a thrust bearing and a thrust collar arranged to axially restrain the thrust bearing. In this case, the set of components may comprise the thrust bearing and thrust collar.

The axial distance between the first and second axial positions may be in the range 10% to 40% of the maximum depth of the impeller recess, preferably in the range 15% to 32% of the maximum depth of the impeller recess.

The depth of the diffuser recess at the first end of the diffuser recess may be in the range 1% to 99% of the maximum depth of the impeller recess. The depth of the diffuser recess at the first end of the diffuser recess may be in the range 5% to 75% of the maximum depth of the impeller recess.

The depth of the diffuser recess at the first end of the diffuser recess may be at least 30% of the maximum depth of the impeller recess.

The turbocharger may be arranged such that, in use, the axial position of the impeller wheel varies. In this case, the turbocharger may comprise a bearing housing containing a bearing assembly arranged to rotatably support the shaft about its axis, wherein the bearing assembly is such that, in use, the shaft may move in the axial direction. The bearing assembly may be a free floating bearing assembly.

In this case, during use, the axial position of the radially outer end of the front surface of the hub may vary between first and second axial limit positions, the first end of the recess having a depth, in the axial direction, such that when the radially outer end of the front surface of the hub is at, or between, the first and second axial limit positions, it is located substantially axially in-line with, or inboard of, the first end of the diffuser recess.

The second end of the recess may be axially located such that when the radially outer end of the front surface of the hub is at, or between, the first and second axial limit positions, it is located axially outboard of, or substantially in-line with, the second end of the diffuser recess. Alternatively, the second end of the diffuser recess may be axially located such that when the radially outer end of the front surface of the hub is at, or between, the first and second axial limit positions, it is located axially inboard of the second end of the diffuser recess.

The first and second axial limit positions may be the furthest axial positions, in each axial direction, respectively, that the impeller wheel moves to in use.

The axial distance between the first and second axial limit positions may be in the range 15 to 40% of the maximum depth of the impeller recess, preferably in the range 19% to 38%, more preferably in the range 21% to 36% of the maximum depth of the impeller recess.

Alternatively, the turbocharger may be arranged such that, in use, the axial position of the impeller wheel is substantially fixed.

According to a sixth aspect of the present disclosure there is provided a turbocharger comprising a compressor and turbine;

the compressor comprising:

a housing having an axial intake and an annular outlet volute;

an impeller mounted on a shaft for rotation about a shaft axis between the axial intake and the annular outlet volute;

the impeller having a plurality of blades extending from a root to a tip, the roots of the blades being attached to a front surface of a hub of the impeller;

an annular diffuser passage surrounding the impeller, the diffuser passage extending along a diffuser passage axis from a diffuser inlet downstream of said plurality of blades to a diffuser outlet communicating with the annular outlet volute;

the diffuser passage being defined by first and second diffuser surfaces of first and second wall members respectively;

the impeller hub being mounted in an annular impeller recess in the first wall member;

the turbine comprising a turbine housing defining an inlet and an outlet, with a turbine wheel rotatably mounted within a chamber disposed between the inlet and outlet, the turbine wheel being drivably coupled to the impeller wheel by the shaft, the shaft being rotatably supported by a bearing assembly;

the turbocharger being arranged such that, in use, the axial position of a radially outer end of the front surface of the impeller hub varies between first and second axial limit positions;

an annular diffuser recess is provided in the first wall member, the diffuser recess extending radially outwardly from first end to a second end, the first end being located at a radially outer end of the impeller recess, the second end being located axially inboard of the first end of the diffuser recess;

wherein the depth of the diffuser recess at the first end of the diffuser is such that when the radially outer end of the front surface of the impeller hub is at, or between, the first and second axial limit positions, the radially outer end of the front surface of the hub is located substantially axially in-line with, or inboard of, the first end of the diffuser recess.

The first and second axial limit positions may be the furthest axial positions, in each axial direction, respectively, that the impeller wheel moves to in use.

The axial distance between the first and second axial limit positions may be in the range 15 to 40% of the maximum depth of the impeller recess, preferably in the range 19% to 38%, more preferably in the range 21% to 36% of the maximum depth of the impeller recess.

The depth of the diffuser recess at the first end of the diffuser recess may be in the range 1% to 99% of the maximum depth of the impeller recess. The depth of the diffuser recess at the first end of the diffuser recess may be in the range 5% to 75% of the maximum depth of the impeller recess.

The depth of the diffuser recess at the first end of the diffuser recess may be at least 30% of the maximum depth of the impeller recess.

According to a seventh aspect of the present disclosure there is provided a method of use of a turbocharger comprising a compressor and turbine;

the compressor comprising:

a housing having an axial intake and an annular outlet volute;

an impeller mounted on a shaft for rotation about a shaft axis between the axial intake and the annular outlet volute;

the impeller having a plurality of blades extending from a root to a tip, the roots of the blades being attached to a front surface of a hub of the impeller;

an annular diffuser passage surrounding the impeller, the diffuser passage extending along a diffuser passage axis from a diffuser inlet downstream of said plurality of blades to a diffuser outlet communicating with the annular outlet volute;

the diffuser passage being defined by first and second diffuser surfaces of first and second wall members respectively;

the impeller hub being mounted in an annular impeller recess in the first wall member;

the turbine comprising a turbine housing defining an inlet and an outlet, with a turbine wheel rotatably mounted within a chamber disposed between the inlet and outlet, the turbine wheel being drivably coupled to the impeller wheel by a shaft rotatably supported by a bearing assembly;

an annular diffuser recess is provided in the first wall member, the diffuser recess extending radially outwardly from first end to a second end, the first end being located at a radially outer end of the impeller recess, the second end being located axially inboard of the first end of the diffuser recess;

wherein, in use, the axial position of a radially outer end of the front surface of the impeller hub varies between first and second axial limit positions; and

wherein the depth of the diffuser recess at the first end of the diffuser is such that when the radially outer end of the front surface of the front surface of the hub is at, or between, the first and second axial limit positions, the radially outer end of the front surface of the hub is located substantially axially in-line with, or inboard of, the first end of the diffuser recess.

Any of the features of any of the above aspects of the disclosure may be combined with any of the features of any of the other aspect in any combination.

### BRIEF DESCRIPTION OF THE DRAWINGS

Specific embodiments of the present disclosure will now be described, by way of example only, with reference to the accompanying drawings, in which:

FIG. 1 is an axial cross-section through a known variable geometry turbocharger;

FIG. 2 is an axial cross-sectional view of a radially inner portion of the compressor of the turbocharger of FIG. 1;

FIG. 3 is a cross-sectional schematic drawing of a radially outer portion of the compressor of the turbocharger of FIG. 1;

FIG. 4 is a cross-sectional schematic drawing of a portion of a compressor of the kind shown in FIGS. 1 to 3, in which the compressor is in accordance with a first embodiment of the disclosure;

FIG. 5 is a cross-sectional schematic drawing of a portion of the compressor shown in FIG. 4;

FIG. 6 is a cross-sectional schematic drawing of a portion of a compressor of the kind shown in FIGS. 1 to 3, in which the compressor is in accordance with a second embodiment of the disclosure;

FIG. 7 is a cross-sectional schematic drawing of a portion of a compressor of the kind shown in FIGS. 1 to 3, in which the compressor is in accordance with a third embodiment of the disclosure;

FIG. 7A is an enlarged view of the diffuser recess shown in FIG. 7;

FIG. 8 is a cross-sectional schematic drawing of a portion of a compressor of the kind shown in FIGS. 1 to 3, in which the compressor is in accordance with a fourth embodiment of the disclosure;

FIG. 9 is a cross-sectional schematic drawing of a portion of a compressor of the kind shown in FIGS. 1 to 3, in which the compressor is in accordance with a fifth embodiment of the disclosure;

FIG. 10 is a cross-sectional schematic drawing of a portion of a compressor of the kind shown in FIGS. 1 to 3, in which the compressor is in accordance with a further embodiment of the disclosure;

FIG. 11 is a cross-sectional schematic drawing of a portion of a compressor of the kind shown in FIGS. 1 to 3, in which the compressor is in accordance with a further embodiment of the disclosure;

FIG. 12 is a cross-sectional schematic drawing of a portion of a compressor of the kind shown in FIGS. 1 to 3, in which the compressor is in accordance with a further embodiment of the disclosure;

### DETAILED DESCRIPTION OF EMBODIMENTS

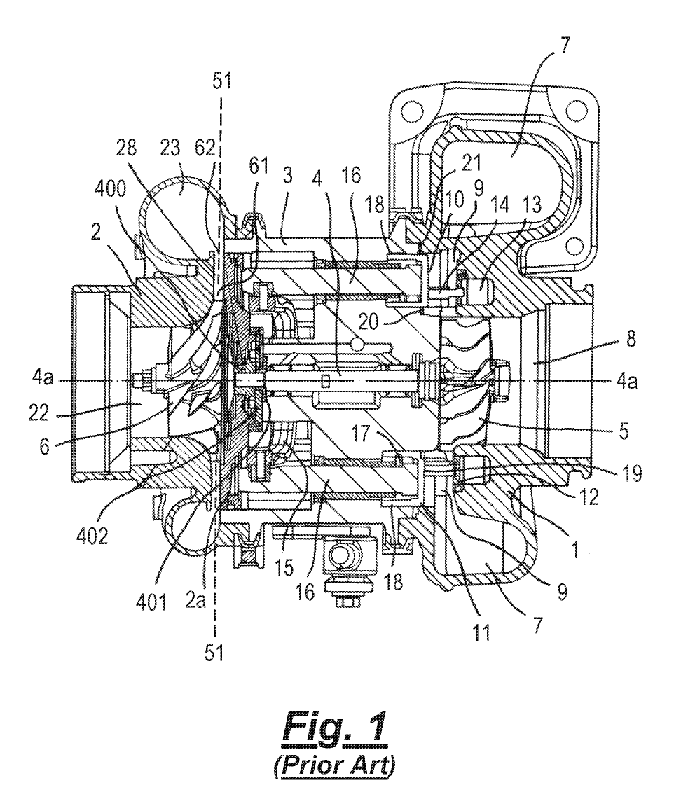

Referring to FIG. 1, this illustrates a known variable geometry turbocharger comprising a housing comprised of a variable geometry turbine housing 1 and a compressor housing 2 (sometimes referred to as a compressor ‘shroud’) interconnected by a central bearing housing 3. A turbocharger shaft 4 extends from the turbine housing 1 to the compressor housing 2 through the bearing housing 3. A turbine wheel 5 is mounted on one end of the shaft 4 for rotation within the turbine housing 1, and an impeller wheel 6 is mounted on the other end of the shaft 4 for rotation within the compressor housing 2. The shaft 4 rotates about turbocharger axis 4a on bearing assemblies located in the bearing housing 3.

The turbine housing 1 defines an inlet volute 7 to which gas from an internal combustion engine (not shown) is delivered. The exhaust gas flows from the inlet volute 7 to an axial outlet passage 8 via an annular inlet passage 9 and the turbine wheel 5. The inlet passage 9 is defined on one side by a face 10 of a radial wall of a movable annular wall member 11, commonly referred to as a “nozzle ring”, and on the opposite side by an annular shroud 12 which forms the wall of the inlet passage 9 facing the nozzle ring 11. The shroud 12 covers the opening of an annular recess 13 in the turbine housing 1.

The nozzle ring 11 supports an array of circumferentially and equally spaced inlet vanes 14 each of which extends across the inlet passage 9. The vanes 14 are orientated to deflect gas flowing through the inlet passage 9 towards the direction of rotation of the turbine wheel 5. When the nozzle ring 11 is proximate to the annular shroud 12, the vanes 14 project through suitably configured slots in the shroud 12, into the recess 13.

The position of the nozzle ring 11 is controlled by an actuator assembly of the type disclosed in U.S. Pat. No. 5,868,552. An actuator (not shown) is operable to adjust the position of the nozzle ring 11 via an actuator output shaft (not shown), which is linked to a yoke 15. The yoke 15 in turn engages axially extending actuating rods 16 that support the nozzle ring 11. Accordingly, by appropriate control of the actuator (which may for instance be pneumatic or electric), the axial position of the rods 16 and thus of the nozzle ring 11 can be controlled. The speed of the turbine wheel 5 is dependent upon the velocity of the gas passing through the annular inlet passage 9. For a fixed rate of mass of gas flowing into the inlet passage 9, the gas velocity is a function of the width of the inlet passage 9, the width being adjustable by controlling the axial position of the nozzle ring 11. FIG. 1 shows the annular inlet passage 9 fully open. The inlet passage 9 may be closed to a minimum by moving the face 10 of the nozzle ring 11 towards the shroud 12.

The nozzle ring 11 has axially extending radially inner and outer annular flanges 17 and 18 that extend into an annular cavity 19 provided in the turbine housing 1. Inner and outer sealing rings 20 and 21 are provided to seal the nozzle ring 11 with respect to inner and outer annular surfaces of the annular cavity 19 respectively, whilst allowing the nozzle ring 11 to slide within the annular cavity 19. The inner sealing ring 20 is supported within an annular groove formed in the radially inner annular surface of the cavity 19 and bears against the inner annular flange 17 of the nozzle ring 11. The outer sealing ring 20 is supported within an annular groove formed in the radially outer annular surface of the cavity 19 and bears against the outer annular flange 18 of the nozzle ring 11.

Gas flowing from the inlet volute 7 to the outlet passage 8 passes over the turbine wheel 5 and as a result torque is applied to the shaft 4 to drive the compressor wheel 6.

The compressor housing 2 comprises an axial intake 22 and an annular outlet volute 23. The impeller wheel 6 is mounted on the shaft 4 at a location between the axial intake 22 and the annular outlet volute 23. Rotation of the impeller wheel 6 within the compressor housing 2 pressurises ambient air present in the intake 22 and delivers the pressurised air to the outlet volute 23 from which it is fed to an internal combustion engine (not shown).

An annular diffuser passage 28 surrounds the impeller wheel 6, the diffuser passage 28 extending along a diffuser passage axis 51 from a diffuser inlet 61 downstream of the impeller 5 to a diffuser outlet 62 communicating with the annular outlet volute 23.

It will be appreciated that references to axially inboard and outboard refer to the axial direction (the direction of the shaft axis) towards and away from the diffuser passage axis 51 respectively. Furthermore, it will be appreciated that references to radial and circumferential refer to the radial and circumferential directions (or positions) relative to the turbocharger axis 4a.

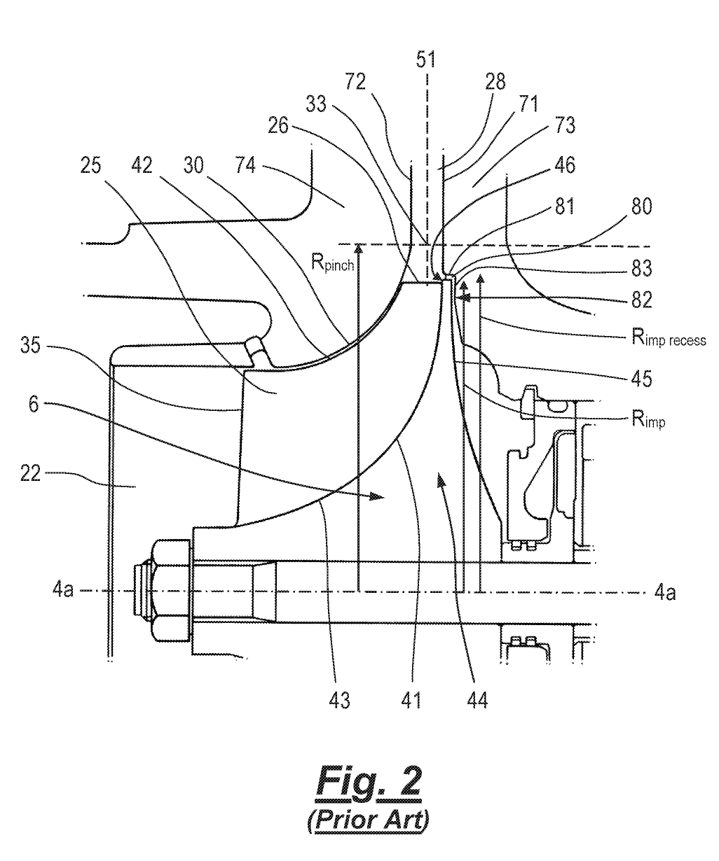

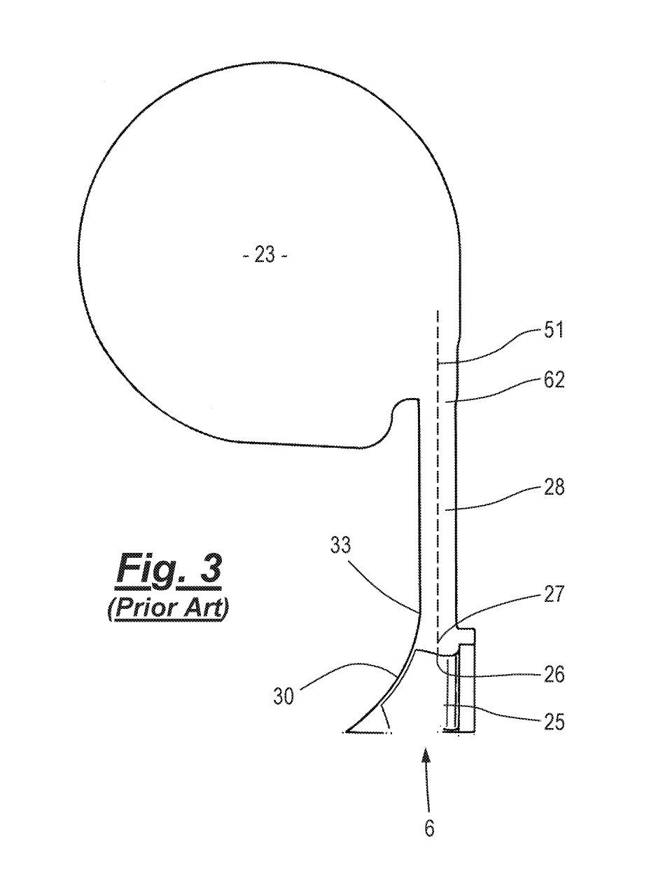

FIGS. 2 and 3 respectively illustrate radially inner and outer sections of a known compressor of the kind used in a turbocharger of the type described above in relation to FIG. 1.

With regard to FIGS. 2 and 3, features common to FIG. 1 will take the same reference numerals. Referring to FIGS. 2 and 3, the compressor impeller wheel 6 has a plurality of blades 25. Each blade 25 extends from a root 41, attached to a front surface 43 of a hub 44 of the impeller, to a tip 42. The hub 44, and its front surface, are substantially annular. The front surface 43 has an annular radially outer end 46.

Each blade 25 has a leading edge 35 which, in use, rotates within the axial intake 22 and a trailing edge 26 which sweeps across the diffuser passage inlet 61. The tip 42 of each blade 25 is curved and extends from the leading edge 35 to the trailing edge 26 of the blade 25. In use, the tips 42 of the impeller blades 25 sweep across an intermediate surface 30 of the compressor housing 2 defined between the axial intake 22 and the diffuser passage 28. The intermediate surface 30 of the compressor housing 2 has a curved shape that is complementary to the curved tips 42 of the blades 25. The hub has a rear surface 45.

The diffuser passage 28 is defined by first and second opposed surfaces 71, 72 of first and second walls 73, 74 of the compressor housing 2 respectively. The first surface 71 is provided on the same axial side of the diffuser passage 28 as the impeller wheel hub 44. The first wall 73 is a wall of a diffuser plate 2a (see FIG. 1) provided between the compressor housing 2 and the bearing housing 3. The second surface 72 is provided on the opposite axial side of the diffuser passage 28 to the impeller wheel hub 44. In this regard, the second surface 72 of the diffuser passage 28 is provided on the same axial side of the diffuser passage as the intermediate surface 30 of the compressor housing 2, and is an extension of the intermediate surface 30.

As can be seen in FIG. 2, a section of the second diffuser surface 72, immediately downstream of the trailing edges 26 of the blades 25 has a smooth, regularly curved profile extending towards the first diffuser surface 71 to point at which the diffuser passage 28 has a minimum cross-sectional area. This is the ‘pinch’ region 33 of the diffuser passage 28. The pinch region 33 is located at a radius Rpinch.

The impeller hub 44 is mounted within an annular impeller recess 80 in the first wall 73 of the compressor housing 2. The impeller recess 80 is defined by an impeller recess surface 82. The impeller recess surface 82 comprises a radially extending surface 83 that is substantially parallel to the diffuser passage axis 51 and an axially extending surface 81 that extends axially inboard from the radially outer end of the radially extending surface 83. The axially extending surface 81 is disposed slightly radially outwardly of the radially outer end of the impeller hub 44. The axially extending surface 81 is located at a radius Rimp recess.

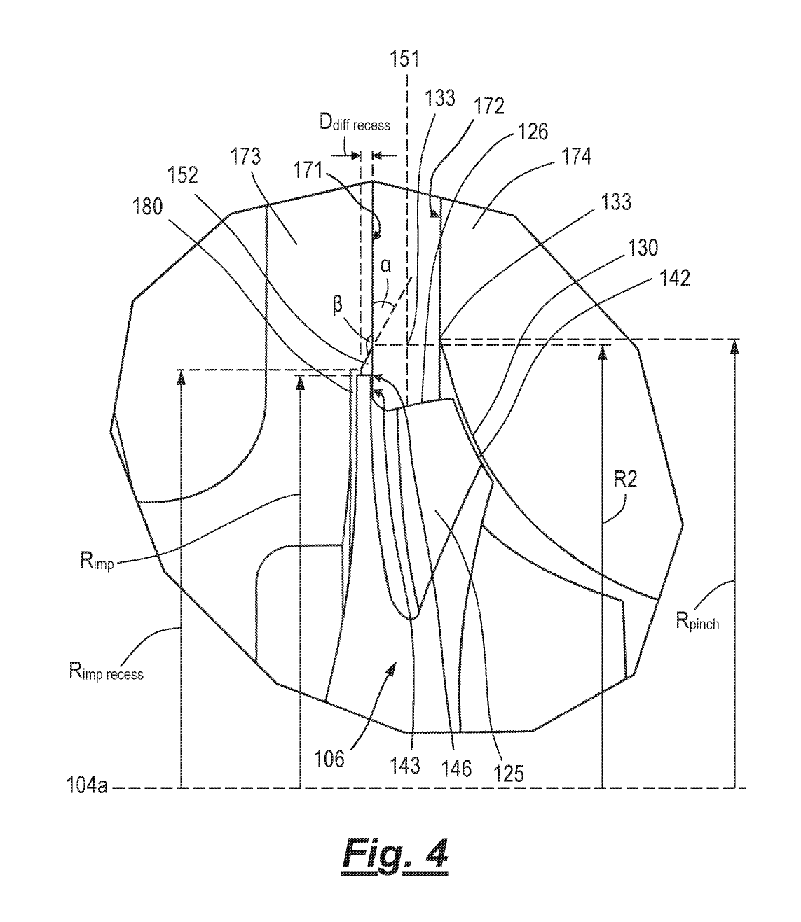

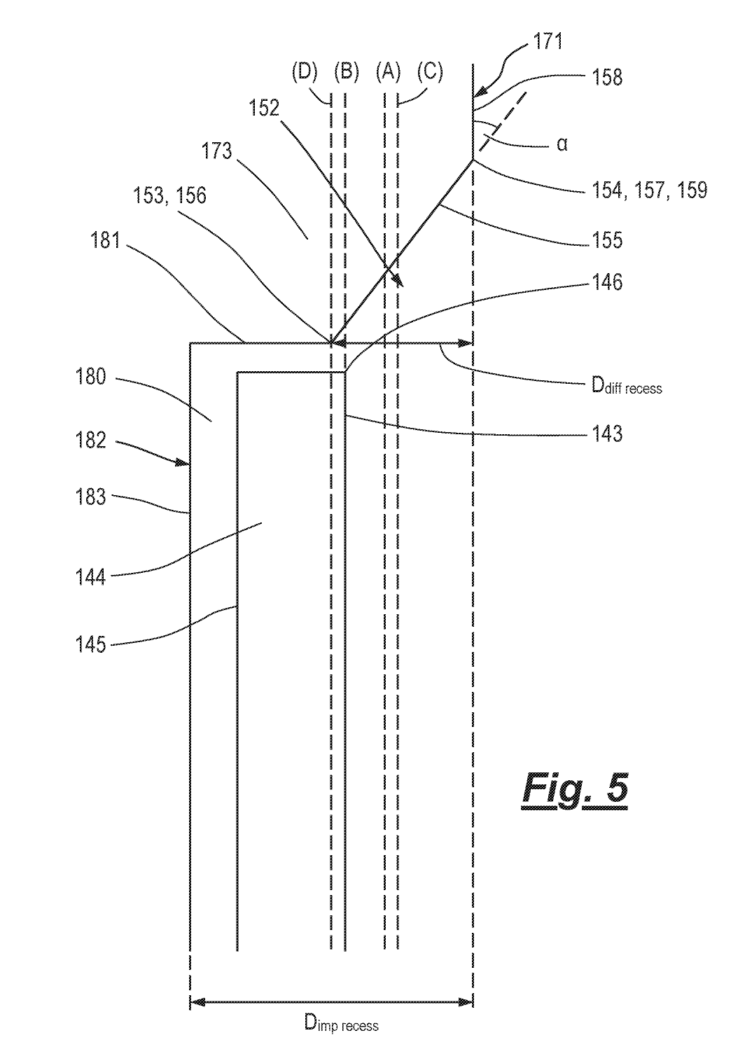

Referring now to FIGS. 4 and 5, there is shown a cross-sectional schematic drawing of a portion of a compressor of the kind shown in FIGS. 1 to 3, in which the compressor is in accordance with a first embodiment of the disclosure.

The compressor shown in FIGS. 4 and 5 is identical to the compressor shown in FIGS. 1 to 3, except for the differences described below. Corresponding features have been given the same reference numerals, but incremented by 100.

A diffuser recess 152 is provided in the first wall member 173. The diffuser recess is substantially annular, extending in the circumferential direction about the shaft axis 104a. The diffuser recess 152 has a cross sectional shape that is substantially constant with circumferential position.

The diffuser recess 152 extends radially outwardly from a first end 153 to a second end 154 (see FIG. 5). The first end 153 is located at the axially inboard end of the radially outer end 181 of the impeller recess 180. The second end 154 is located axially inboard of the first end 153 of the diffuser recess 152.

In this regard, the first diffuser surface 171 comprises a first section 155 that defines the diffuser recess 152. The first section 155 extends from a first end 156 at the first end 153 of the diffuser recess 152, to a second end 157 at the second end 154 of the diffuser recess 152.

The first diffuser surface 171 also comprises a second section 158 that extends radially outwardly from a first end 159, at the second end 154 of the diffuser recess 180, to a second end (not shown). The second end is provided at the diffuser outlet. The second section 158 is substantially planar and is substantially parallel to the diffuser passage axis 151.

The impeller recess 180 has an axial depth Dimp recess. It will be appreciated that references to axial depth refers to the axial distance from the second section 158 of the first diffuser surface 171, specifically the first end 159 of the second section 158. This is also the axial depth from the second end 154 of the diffuser recess 152.

In this regard, the impeller recess 180 has an axial depth Dimp recess that is the axial distance between the radially extending surface 183 of the impeller recess surface 182 and the second section 158 of the first diffuser surface 171, specifically the first end 159 of the second section 158. In this regard, it will be appreciated that the axial depth Dimp recess is the axial distance between the radially extending surface 183 of the impeller recess surface 182 and the second end 154 of the diffuser recess 152.

The axial depth Dimp recess is substantially constant with radial (and circumferential) position. The maximum axial depth Dimp recess of the impeller recess 180 is therefore the constant axial depth Dimp recess.

The diffuser recess 152 has an axial depth Ddiff recess. In this regard, the axial depth Ddiff recess at the first end 153 is the axial distance between the first end 153 of the diffuser recess 152 and the second section 158 of the first diffuser surface 171, specifically the first end 159 of the second section 158. In this regard, it will be appreciated that the axial depth Ddiff recess is the axial distance between the first end 153 of the diffuser recess 152 and the second end 154 of the diffuser recess 152.

The axial depth Ddiff recess increases linearly from the second end 154 to the first end 153 of the diffuser recess 152. The maximum axial depth of the diffuser recess 152 is the depth D1 of the diffuser recess 152 at the first end 153 of the diffuser recess 152.

In the embodiment shown in FIGS. 4 and 5, the depth Ddiff recess of the diffuser recess 152 at the first end 153 of the diffuser recess 152 is 35% of the maximum axial depth Dimp recess of the impeller recess 180.

This may allow components of the compressor to have manufacturing tolerances such that, at any axial position of the manufactured impeller wheel, due to the tolerances of the set of components of the compressor, the radially outer end 146 of the front surface 143 of the hub 144 is located substantially axially in-line with, or inboard of, the first end 153 of the diffuser recess 152. This may reduce losses in the flow through the diffuser passage 128.

In contrast, if the radially outer end 146 of the front surface 143 of the hub 144 was axially outboard of the first end 153 of the diffuser recess 152, this could result in flow “tripping off” the trailing edge 126 of the impeller blades 125, resulting in increased turbulence and loss of performance, as well as communicating higher static pressures behind the impeller wheel 106, which in turn would increase the thrust load on the compressor. This would also increases the blow past gases past seals on the impeller wheel 106, in to the bearing system and engine crankcase.

Accordingly, the above arrangement ensures consistent performance of the compressor, since it is not the case that, due to the manufacturing tolerances, the radially outer end 146 of the front surface 143 of the impeller is sometimes outboard of the first end 153 of the diffuser recess 152.

In this regard, in the currently described embodiment, the radially outer end 146 of the front surface 143 of the impeller hub 144 is located axially inboard of the first end 153 of the diffuser recess 152. Alternatively, the radially outer end 146 of the front surface 143 of the impeller hub 144 may be located substantially axially in-line with the first end 153 of the diffuser recess 152.

In the currently described embodiment, the first end 153 of the diffuser recess 152 is located axially inboard of the rear surface 145 of the impeller hub 144. Alternatively, the first end 153 of the diffuser recess 152 may be located substantially axially in-line with the rear surface 145 of the impeller hub 144.

The second end 154 of the diffuser recess 152 is located at a radius R2 (relative to the turbocharger axis 104a) (see FIG. 4). The second end 154 of the diffuser recess 152 is located radially inwardly of the radial location Rpinch of the pinch area 133. In this regard, the second end 154 of the diffuser recess 152 is located at a radius R2 of 95% of the radius of the radial location Rpinch of the pinch area 133.

The first end 153 of the diffuser recess 152 is located at a radius of 92% of the radius of the radial location Rpinch of the pinch area 133.

The first and second sections 155, 158 of the first diffuser surface 171 are inclined relative to each other. In this respect, at each circumferential location of the first section 155 of the first diffuser surface 171, in the axial plane, the first and second sections 155, 158 are inclined relative to each other.

It will be appreciated that the ‘axial plane’ at a circumferential location refers to a plane defined by the axial direction and by the radial direction at that circumferential location. In this regard, the turbocharger axis 104a and the radial axis (the axis in the radial direction, at that circumferential location) are substantially contained within the axial plane. The turbocharger axis 104a and the radial axis are substantially parallel to the axial plane. The axial plane passes through the turbocharger axis 104a.

In this regard, at each circumferential location of the first section 155 of the first diffuser surface, in the axial plane, the first section 155 is substantially straight and is inclined relative to the second section 158 at an angle such that two supplementary angles (α, β) are formed between the first section 155 and the second section 158, a first acute angle (α) and second obtuse angle (β). In the currently described embodiment the first acute angle (α) is 10°.

The shape of the diffuser recess 152 smoothly guides the flow from the compressor wheel 106 to the diffuser passage 128, thereby reducing losses in the flow.

Referring now to FIG. 5, the compressor comprises a set of components where each component in the set has a manufacturing tolerance such that in the manufactured compressor, the component has a physical dimension (e.g. an axial length) that varies from a first value to a second value, wherein when the physical dimension of the component is at the first value the radially outer end 146 of the front surface 143 of the impeller hub 144 is caused to be located axially inboard of when the physical dimension of the component is at the second value.

When the physical dimension of each component in the set of components is at the first value, the radially outer end 146 of the front surface 143 of the hub 144 is located at a first axial position (A) relative to the second section 158 of the first diffuser surface 171 and when the physical dimension of each component in the set of components is at the second value, the radially outer end 146 of the front surface 143 of the hub 144 is located at a second axial position (B) relative to the second section 158 of the first diffuser surface 171, the first axial position (A) being located axially inboard of the second axial position (B).

The axial distance between the first and second axial positions (A), (B) is 20% of the maximum depth of the impeller recess.

The depth Ddiff recess of the diffuser recess 152 at the first end 153 of the diffuser recess 152 is such that when the radially outer end 146 of the front surface 143 of the hub surface 144 is at, or between, the first and second axial positions (A, B), the radially outer end 146 of the front surface 143 of the hub 144 is located substantially axially in-line with, or inboard of, the first end 153 of the diffuser recess 152.

The second end 154 of the diffuser recess is axially located such that when the radially outer end 146 of the front surface 143 of the hub 144 is at, or between, the first and second axial positions (A, B), it is located axially outboard of, or substantially in-line with, the second end 154 of the diffuser recess 152. Alternatively, the second end 154 of the diffuser recess may be axially located such that when the radially outer end 146 of the front surface 143 of the hub 144 is at, or between, the first and second axial positions (A, B), it is located axially inboard of the second end 154 of the diffuser recess 152.

In the above arrangement, at any axial position of the manufactured impeller wheel, due to the tolerances of the set of components of the compressor, the radially outer end 146 of the front surface 143 of the hub 144 of the impeller is located substantially axially in-line with, or inboard of, the first end 153 of the diffuser recess 152. This ensures consistent performance of the compressor, since it is not the case that, due to the manufacturing tolerances, the radially outer end 146 of the front surface 143 of the hub 144 is sometimes outboard of the first end 153 of the diffuser recess 152.

The turbocharger comprises an oil slinger 400 (see FIG. 1) mounted on the shaft, so as to rotate with the shaft such that it directs lubricating fluid away from the shaft 104. The turbocharger also comprises a thrust collar (not shown). The thrust collar is axially adjacent to a thrust bearing 402 and is arranged to constrain the axial movement of the thrust bearing 402.

In the currently described embodiment, the set of components comprises the impeller wheel 144, the oil slinger, the thurst bearing 402 and the thrust collar. It will be appreciated that the set of components may comprise different components of the turbocharger.

The physical dimension that varies for the thrust collar and the oil slinger 400, that contributes to the axial position of the impeller wheel as stated above, is the overall axial length of the thrust collar and oil slinger respectively.

The physical dimension that varies for the thrust bearing 402 that contributes to the axial position of the impeller wheel as stated above, is the width of the thrust bearing 402.

During use, the axial position of the radially outer end 146 of the front surface 143 of the hub 144 varies between first and second axial limit positions (C, D) relative to the second section 158 of the first diffuser surface 171. The first axial limit position (C) is inboard of the second axial position (D). The first and second axial limit positions (C, D) are the furthest axial positions, in each axial direction respectively, that the radially outer end 146 of the front surface 143 of the impeller wheel hub 44 moves to in use. This axial movement is due to axial movement (′shuttle) of the impeller wheel 106 caused by an imbalance in pressure forces, in the axial direction on the impeller wheel 106. The bearing assembly is such that, in use, the shaft 104a may move in the axial direction due to these pressure forces. The bearing assembly is a free floating bearing assembly.

The axial distance between the first and second axial limit positions is 25% of the maximum depth of the impeller recess.

Accordingly, the overall axial limit positions of the radially outer end 146 of the front surface 143 of the hub 144, varies in dependence on the pressure forces exerted on the impeller wheel, in combination with the above stated manufacturing tolerances, i.e. the overall axial limit positions (C), (D) are due to the sum of the movement of the impeller wheel in use and the variation in axial position due to said tolerances.

The depth Ddiff recess of the diffuser recess 152 at the first end 153 of the diffuser recess 152 is such that when the radially outer end 146 of the front surface 143 of the hub 144 is at, or between, the first and second axial limit positions (C, D), the radially outer end 146 of the front surface 143 of the hub 144 is located substantially axially in-line with, or inboard of, the first end 153 of the diffuser recess 152.

The second end 154 of the diffuser recess is axially located such that when the radially outer end 146 of the front surface 143 of the hub 144 is at, or between, the first and second axial limit positions (C, D), it is located axially outboard of, or substantially in-line with, the second end 154 of the diffuser recess 152. Alternatively, the second end 154 of the diffuser recess may be axially located such that when the radially outer end 146 of the front surface 143 of the hub 144 is at, or between, the first and second axial limit positions (C, D), it is located axially inboard of the second end 154 of the diffuser recess 152.

The above arrangement provides the features stated above in relation to the first and second axial positions (A, B).

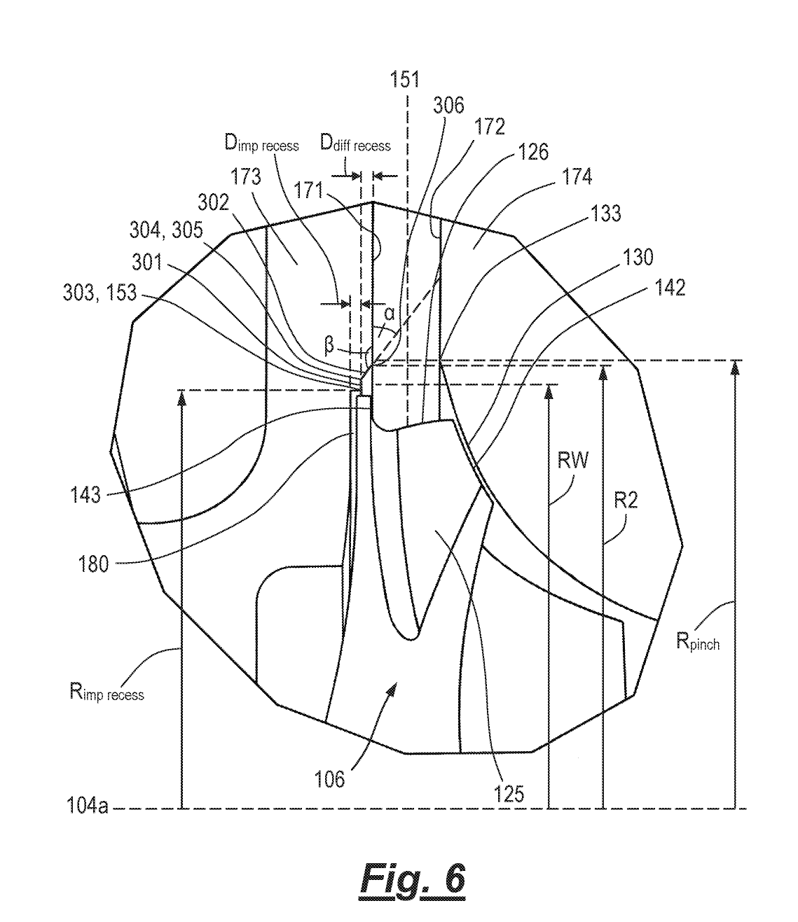

Referring to FIG. 6, there is shown a cross-sectional schematic drawing of a portion of a compressor of the kind shown in FIGS. 1 to 3, in which the compressor is in accordance with a second embodiment of the disclosure.

The compressor shown in FIG. 6 is identical to the compressor shown in FIGS. 4 and 5, except for the differences described below. Corresponding features have been given the same reference numerals.

The compressor shown in FIG. 6 differs from that shown in FIGS. 4 and 5 in that the first section 155 of the first diffuser surface 171 comprises first and second portions 301, 302.

The first portion 301 extends radially outwardly from a first end, 303 at the first end 156 of the first section 155, to a second end 304. The second portion 302 extends radially outwardly from a first end 305, at the second end 304 of the first portion, to a second end 306 at the second end 157 of the first section 155.

The first portion 301 extends substantially parallel to the second section 158 of the first diffuser surface 171. Alternatively, the first portion 301 may be inclined relative to the second section 158. In this regard, the first portion may extend in the axially inboard direction, from its first end to its second end, as shown in FIG. 8. The first and/or second portions 301, 302 may be curved along their radial lengths such that they curve in the axially inboard direction, from their first end to their second end.

The first and second portions 301, 302 are inclined relative to each other. In this respect, at each circumferential location of the first section of the first diffuser surface, in the axial plane, the first and second portions 301, 302 are inclined relative to each other.

The second portion 302 is inclined relative to the second section 158 of the first diffuser surface 171. In this respect, at each circumferential location of the first section 155 of the first diffuser surface 171, in the axial plane, the second portion 302 is substantially straight and is inclined relative to the second section 158 of the first diffuser surface 171. The second portion 302 is inclined relative to the second section 158 of the first diffuser surface 171 at an angle such that two supplementary angles are formed between the second portion 302 and the second section 158, a first acute angle (α) and second obtuse angle (β). In the currently described embodiment the first angle (α) is 14°.

In the embodiment shown in FIG. 6, the depth of the diffuser recess 152 at the first end 153 of the diffuser recess 152 is 22% of the maximum axial depth Dimp recess of the impeller recess 180.

The first end 153 of the diffuser recess 152 is located at a radius of 96% of the radius of the radial location Rpinch of the pinch area 133.

The second end 154 of the diffuser recess 152 is located at a radius R2 of 99% of the radius of the radial location Rpinch of the pinch area 133.

The second end 304 of the first portion 301 of the first section 155 of the first diffuser surface 171 is located at a radius RW of 97% of the radius of the radial location Rpinch of the pinch area 133.

Towards its second end 304, the first portion 301 may be curved in the direction of the second portion 302. Towards its first end 305, the second portion 302 may be curved in the direction of the first portion 301.

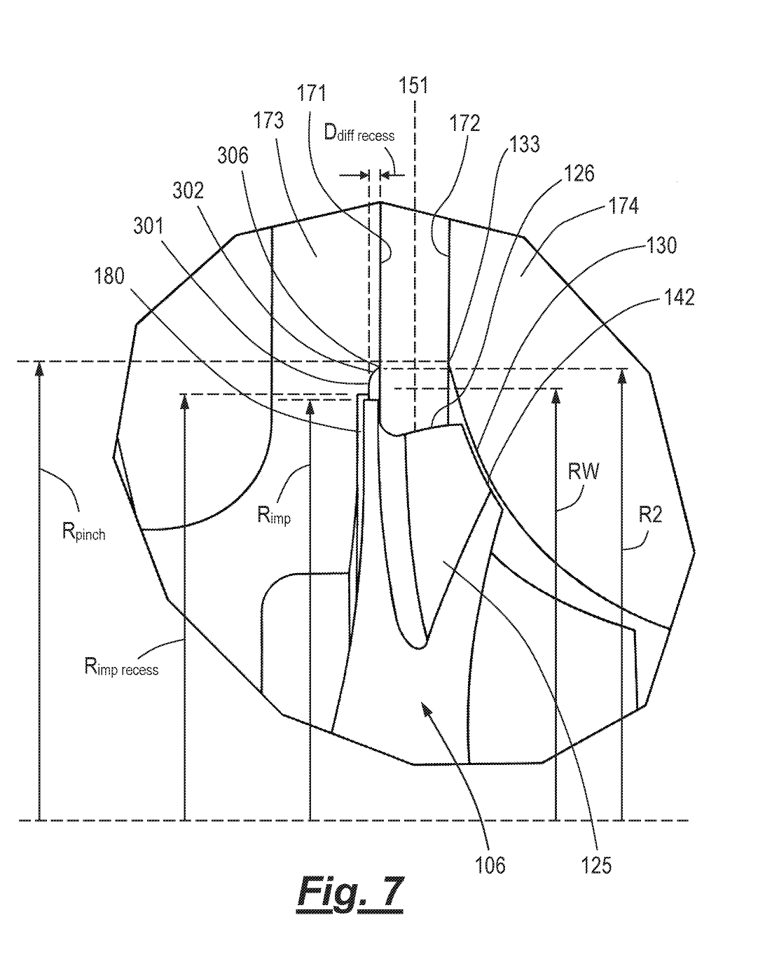

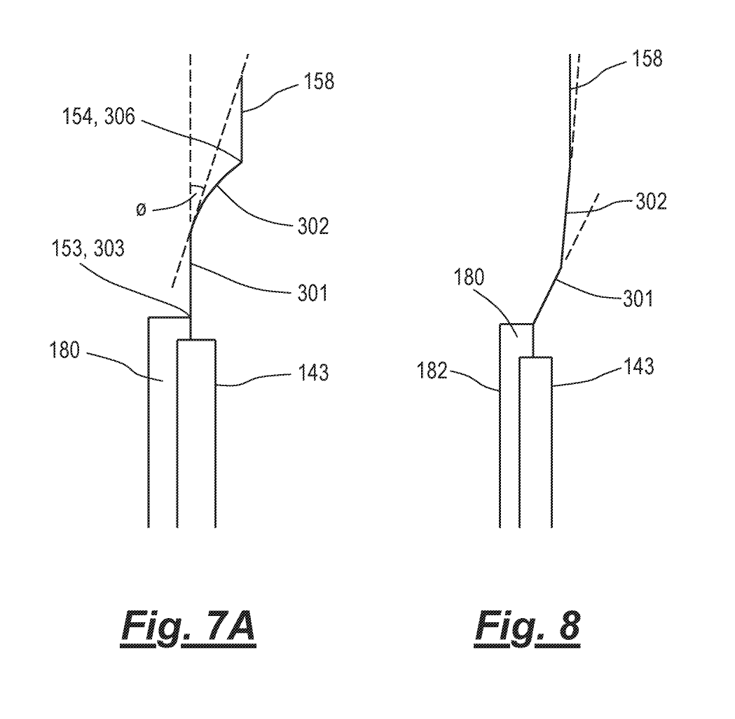

Referring to FIG. 7, there is shown a cross-sectional schematic drawing of a portion of a compressor of the kind shown in FIGS. 1 to 3, in which the compressor is in accordance with a third embodiment of the disclosure.

The compressor shown in FIG. 7 is identical to the compressor shown in FIG. 6, except for the differences described below. Corresponding features have been given the same reference numerals.

The compressor shown in FIG. 7 differs from that shown in FIG. 6 in that the second portion 302 is curved along its radial length. The second portion 302 forms a concave curve.

In this respect, at each circumferential location of the first section 155 of the first diffuser surface 171, in the axial plane, the second portion 302 curves, from its first end 305 to its second end 306, in the axially inboard direction (see FIG. 7A).

At the second end 304 of the first portion 301, the second portion 302 (the tangent to the second portion at that point) is inclined relative to the first portion 301 at an angle such that two supplementary angles are formed between the first and second portions, a first acute angle (\textcircled{−}) and second obtuse angle, wherein the first angle (\textcircled{−}) is 35. The first angle (\textcircled{−}) may be less than 40°.

In the embodiment shown in FIG. 7, the depth of the diffuser recess 152 at the first end 153 of the diffuser recess 152 is 22% of the maximum axial depth Dimp recess of the impeller recess 180.

The first end 153 of the diffuser recess 152 is located at a radius of 96% of the radius of the radial location Rpinch of the pinch area 133.

The second end 154 of the diffuser recess 152 is located at a radius R2 of 99% of the radius of the radial location Rpinch of the pinch area 133.

The second end 304 of the first portion 301 of the first section 155 of the first diffuser surface 171 is located at a radius RW of 97% of the radius of the radial location Rpinch of the pinch area 133.

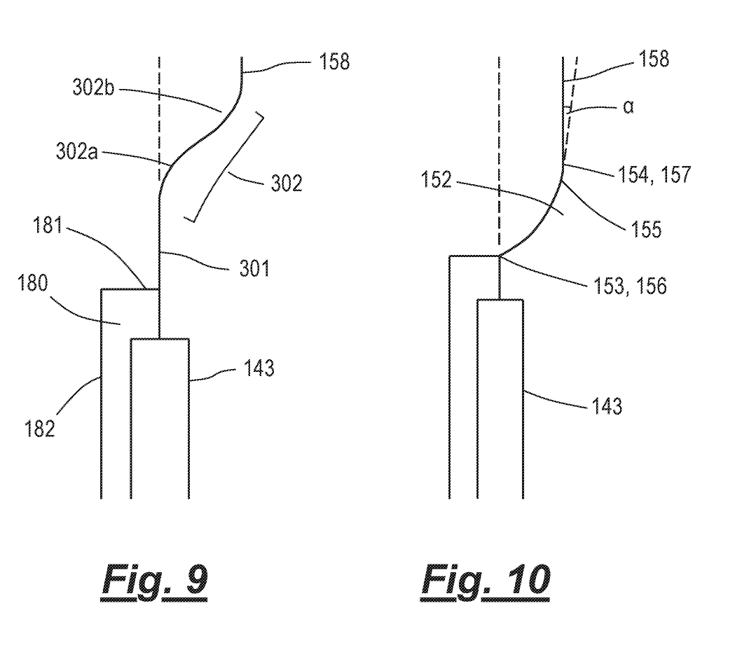

Referring to FIG. 9, there is shown a further embodiment of the disclosure. The compressor of this embodiment is identical to the compressor shown in FIG. 6, except for the differences described below. Corresponding features have been given the same reference numerals.

The compressor of this embodiment differs from that of FIG. 6 in that the second portion 302 comprises first and second sections 302a, 302b. The first section 302a extends radially outwardly from a first end, at the second end of the first portion to a second end and the second section 302b extends radially outwardly from a first end, at the second end of the first section 302a to a second end at the first end of the second section 158 of the first diffuser surface 171. The first and second sections 302a, 302b are inclined relative to each other. In this regard, at each circumferential location, the first and second sections 302a, 302b are inclined relative to each other in the axial plane.

The first section 302a curves axially inboard, from its first end to its second end. At its first end, the second section 302b has substantially the same angle of inclincation, relative to the axial direction, as the first section 302a. The second section 302b curves from its first end to its second end, but in the opposite sense to that of the first section 302a so as to form a general S-shape when viewed in an axial plane (as shown in FIG. 9). In this regard, as the second section 302b curves from its first end to its second end, so as to become more parallel with the diffuser passage axis 151. At its second end, the second section 302b is substantially parallel to the diffuser passage axis 151.

FIG. 10 is a cross-sectional schematic drawing of a portion of a compressor of the kind shown in FIGS. 1 to 3, in which the compressor is in accordance with a further embodiment of the disclosure.

This embodiment is identical to that shown in FIGS. 4 and 5, except for the differences described below. Corresponding features are given the same reference numerals.

This embodiment differs from the shown in FIGS. 4 and 5 in that the first section 155 of the first diffuser surface 171 forms a convex curve, from its first end 156 to its second end 157.

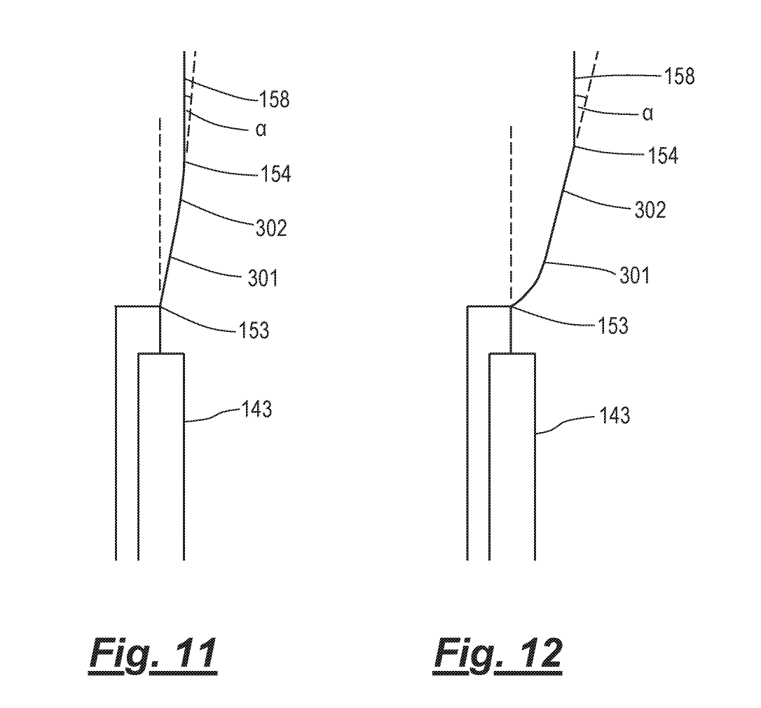

FIG. 11 is a cross-sectional schematic drawing of a portion of a compressor of the kind shown in FIGS. 1 to 3, in which the compressor is in accordance with a further embodiment of the disclosure.

This embodiment is identical to that shown in FIG. 6, except for the differences described below. Corresponding features are given the same reference numerals.

This embodiment differs from that shown in FIG. 6 in that at each circumferential location of the first portion 301, in the axial plane, the first portion 301 is substantially straight and is inclined relative to the second section 158 at an angle towards the axially inboard direction.

In addition, the second portion 302 forms a convex curve, from its first end to its second end.

At its second end, the second portion 302 is inclined relative to the second section 158 at an angle such that two supplementary angles (α, β) are formed between the second portion 302 and the second section 158, a first acute angle (α) and second obtuse angle (β). In the currently described embodiment the first acute angle (α) is 10°.

FIG. 12 is a cross-sectional schematic drawing of a portion of a compressor of the kind shown in FIGS. 1 to 3, in which the compressor is in accordance with a further embodiment of the disclosure.

This embodiment is identical to that shown in FIG. 11, except for the differences described below. Corresponding features are given the same reference numerals.

This embodiment differs from the shown in FIG. 11 in that the first portion 301 forms a convex curve, from its first end to its second end.

At each circumferential location of the second portion 302, in the axial plane, the second portion 302 is substantially straight and is inclined relative to the second section 158 at an angle such that two supplementary angles (α, β) are formed between the second portion 302 and the second section 158, a first acute angle (α) and second obtuse angle (β). In the currently described embodiment the first acute angle (α) is 10°.

The embodiments shown in FIGS. 6 to 12 provide the features described as for the embodiment shown in FIGS. 4 and 5.

While the disclosure has been illustrated and described in detail in the drawings and foregoing description, the same is to be considered as illustrative and not restrictive in character, it being understood that only the preferred embodiments have been shown and described and that all changes and modifications that come within the scope of the disclosures as defined in the claims are desired to be protected.

For example, in each of the above described embodiments, the depth Ddiff recess of the diffuser recess 152 at the first end 153 of the diffuser recess 152 may be in the range 1% to 99% of the maximum depth of the impeller recess. The depth Ddiff recess of the diffuser recess at the first end of the diffuser recess may be in the range 5% to 75% of the maximum depth of the impeller recess. The depth Ddiff recess of the diffuser recess at the first end of the diffuser recess may be at least 30% of the maximum depth of the impeller recess. The depth Ddiff recess of the diffuser recess at the first end of the diffuser recess may be greater than or equal to 40% of the maximum depth of the impeller recess. The depth Ddiff recess of the diffuser recess at the first end of the diffuser recess may be greater than or equal to 50% of the maximum depth of the impeller recess. The depth of the diffuser recess at the first end of the diffuser recess may be in the range 35% to 75% of the maximum depth of the impeller recess. The depth of the diffuser recess at the first end of the diffuser recess may be in the range 35% to 60% of the maximum depth of the impeller recess.

In the above described embodiments, the first angle (α) may be in the range 1° to 44.9°, preferably in the range 1° to 44°, more preferably in the range 1° to 40°.

In the described embodiments, the second end of the diffuser recess is located radially inwardly of the radial location of the minimum cross-sectional area of the diffuser passage. Alternatively, the second end of the diffuser recess may be located substantially radially in-line with the radial location of the minimum cross-sectional area of the diffuser passage.

The second end of the diffuser recess may be located at a radius in the range 70% to 100% of the radius of the radial location at which the cross-sectional area of the diffuser passage is a minimum. The second end of the diffuser recess may be located at a radius in the range 73% to 90% of the radius of the radial location at which the cross-sectional area of the diffuser passage is a minimum.

The first end of the diffuser recess may be located at a radius in the range 60% to 99% of the radius of the radial location at which the cross-sectional area of the diffuser passage is a minimum. The first end of the diffuser recess may be located at a radius in the range 76% to 99% of the radius of the radial location at which the cross-sectional area of the diffuser passage is a minimum.

The axial distance between the first and second axial positions (A), (B) may be in the range 10% to 40% of the maximum depth of the impeller recess, preferably in the range 15% to 32% of the maximum depth of the impeller recess

The axial distance between the first and second axial limit positions may be in the range 15 to 40% of the maximum depth of the impeller recess, preferably in the range 19% to 38%, more preferably in the range 21% to 36% of the maximum depth of the impeller recess.

In the described embodiments, the compressor is arranged such that, in use, the axial position of the impeller wheel 106 varies. Alternatively, the compressor may be arranged such that, in use, the axial position of the impeller wheel 106 is substantially fixed.

In the described embodiments the turbine is a variable geometry turbine. Alternatively, the turbine may be a fixed geometry turbine.

The compressor of the described embodiments may be used in applications other than that of a turbocharger.

It should be understood that while the use of words such as preferable, preferably, preferred or more preferred utilized in the description above indicate that the feature so described may be more desirable, it nonetheless may not be necessary and embodiments lacking the same may be contemplated as within the scope of the disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. For the avoidance of doubt, optional and/or preferred features as set out herein may be used either individually or in combination with each other where appropriate and particularly in the combinations as set out in the accompanying claims. The optional and/or preferred features for each aspect of the disclosure set out herein are also applicable to any other aspects of the disclosure, where appropriate.

1. A compressor comprising:
a housing having an axial intake and an annular outlet volute;
an impeller mounted on a shaft for rotation about a shaft axis between the axial intake and the annular outlet volute;
the impeller having a plurality of blades extending from a root to a tip, the roots of the blades being attached to a front surface of a hub of the impeller;
an annular diffuser passage surrounding the impeller, the diffuser passage extending along a diffuser passage axis from a diffuser inlet downstream of said plurality of blades to a diffuser outlet communicating with the annular outlet volute;
the diffuser passage being defined by first and second diffuser surfaces of first and second wall members respectively;
the impeller hub being mounted in an annular impeller recess in the first wall member;
wherein an annular diffuser recess is provided in the first wall member, the diffuser recess extending radially outwardly from a first end to a second end, the first end being located at a radially outer end of the impeller recess, the second end being located axially inboard of the first end of the diffuser recess; and
wherein the depth of the diffuser recess at the first end of the diffuser recess is at least 30% of the maximum depth of the impeller recess.

2. A compressor according to claim 1 wherein the depth of the diffuser recess at the first end of the diffuser recess is greater than 30% of the maximum depth of the impeller recess.

3. A compressor according to claim 1 wherein the depth of the diffuser recess at the first end of the diffuser recess is in the range 35% to 75% of the maximum depth of the impeller recess.

4. A compressor according to claim 1 wherein the cross-sectional area of the diffuser passage, about the diffuser passage axis, decreases from the diffuser inlet to the radial location at which the cross-sectional area of the diffuser passage is a minimum, wherein the second end of the diffuser recess is located substantially radially in-line with, or radially inwardly of, the radial location of the minimum cross-sectional area of the diffuser passage.

5. A compressor according to claim 4 wherein the second end of the diffuser recess is located at a radius in the range 70% to 100% of the radius of the radial location at which the cross-sectional area of the diffuser passage is a minimum.

6. A compressor according to claim 1 wherein the first diffuser surface comprises a first section that defines the diffuser recess, the first section extending radially outwardly from a first end at the first end of the diffuser recess, to a second end at the second end of the diffuser recess and a second section that extends radially outwardly from a first end, at the second end of the diffuser recess, to a second end, wherein the first and second sections are inclined relative to each other.

7. A compressor according to claim 6 wherein the first section of the first diffuser surface is inclined relative to the second section of the first diffuser surface at an angle such that two supplementary angles are formed between the first section and the second section, a first acute angle and second obtuse angle, wherein the first angle is in the range 1° to 44.9°.

8. A compressor according to claim 6 wherein the first section of the first diffuser surface comprises first and second portions, the first portion extending radially outwardly from a first end, at the first end of the first section, to a second end and the second portion extending radially outwardly from a first end, at the second end of the first portion, to a second end at the second end of the first section, wherein the first and second portions are inclined relative to each other.

9. A compressor according to claim 8 wherein the second portion is inclined relative to the second section of the first diffuser surface.

10. A compressor according to claim 9 wherein the second portion is inclined relative to the second section of the first diffuser surface at an angle such that two supplementary angles are formed between the second portion and the second section, a first acute angle and second obtuse angle, wherein the first angle is in the range 1° to 44.9°.

11. A compressor according to claim 8 wherein the second portion is at least part curved along its radial length.

12. A compressor according to claim 8 wherein the second portion comprises a plurality of sections that are inclined relative to each other.

13. A compressor comprising:
a housing having an axial intake and an annular outlet volute;
an impeller mounted on a shaft for rotation about a shaft axis between the axial intake and the annular outlet volute;
the impeller having a plurality of blades extending from a root to a tip, the roots of the blades being attached to a front surface of a hub of the impeller; and
an annular diffuser passage surrounding the impeller, the diffuser passage extending along a diffuser passage axis from a diffuser inlet downstream of said plurality of blades to a diffuser outlet communicating with the annular outlet volute;
the diffuser passage being defined by first and second diffuser surfaces of first and second wall members respectively;
the impeller hub being mounted in an annular impeller recess in the first wall member;
wherein an annular diffuser recess is provided in the first wall member, the diffuser recess extending radially outwardly from a first end to a second end, the first end being located at a radially outer end of the impeller recess, the second end being located axially inboard of the first end of the diffuser recess;
the first diffuser surface comprises a first section that defines the diffuser recess, the first section extending radially outwardly from a first end at the first end of the diffuser recess, to a second end at the second end of the diffuser recess and a second section that extends radially outwardly from a first end, at the second end of the diffuser recess, to a second end;
wherein the first section of the first diffuser surface is inclined relative to the second section of the first diffuser surface at an angle such that two supplementary angles are formed between the first section and the second section, a first acute angle and second obtuse angle, wherein the first angle is in the range 1° to 44.9°.

14. A compressor according to claim 13 wherein the first angle is in the range 1° to 44°.

15. A compressor according to claim 13 wherein the depth of the diffuser recess at the first end of the diffuser recess is at least 30% of the maximum depth of the impeller recess.

16. A compressor comprising:
a housing having an axial intake and an annular outlet volute;
an impeller mounted on a shaft for rotation about a shaft axis between the axial intake and the annular outlet volute;
the impeller having a plurality of blades extending from a root to a tip, the roots of the blades being attached to a front surface of a hub of the impeller; and
an annular diffuser passage surrounding the impeller, the diffuser passage extending along a diffuser passage axis from a diffuser inlet downstream of said plurality of blades to a diffuser outlet communicating with the annular outlet volute;
the diffuser passage being defined by first and second diffuser surfaces of first and second wall members respectively;
the impeller hub being mounted in an annular impeller recess in the first wall member;
wherein an annular diffuser recess is provided in the first wall member, the diffuser recess extending radially outwardly from a first end to a second end, the first end being located at a radially outer end of the impeller recess, the second end being located axially inboard of the first end of the diffuser recess;
the first diffuser surface comprises a first section that defines the diffuser recess, the first section extending radially outwardly from a first end at the first end of the diffuser recess, to a second end at the second end of the diffuser recess and a second section that extends radially outwardly from a first end, at the second end of the diffuser recess, to a second end;
the first section of the first diffuser surface comprising first and second portions, the first portion extending radially outwardly from a first end, at the first end of the first section, to a second end and the second portion extending radially outwardly from a first end, at the second end of the first portion, to a second end at the second end of the first section;
wherein the first and second portions are inclined relative to each other.

17. A turbocharger comprising a compressor according to claim 1 further comprising a turbine wheel coupled to said shaft so as to drivably rotate the impeller.

18. A turbocharger comprising:
a compressor and a turbine;
the compressor comprising;
a housing having an axial intake and an annular outlet volute;
an impeller mounted on a shaft for rotation about a shaft axis between the axial intake and the annular outlet volute;
the impeller having a plurality of blades extending from a root to a tip, the roots of the blades being attached to a front surface of a hub of the impeller; and
an annular diffuser passage surrounding the impeller, the diffuser passage extending along a diffuser passage axis from a diffuser inlet downstream of said plurality of blades to a diffuser outlet communicating with the annular outlet volute;
the diffuser passage being defined by first and second diffuser surfaces of first and second wall members respectively;
the impeller hub being mounted in an annular impeller recess in the first wall member;
the turbine comprising;
a turbine housing defining an inlet and an outlet, with a turbine wheel rotatably mounted within a chamber disposed between the inlet and outlet, the turbine wheel being drivably coupled to the impeller wheel by the shaft, the shaft being rotatably supported by a bearing assembly;
the turbocharger comprising;
a set of components, each component having a manufacturing tolerance such that in the manufactured turbocharger, the component has a physical dimension that may vary from a first value to a second value, when the physical dimension of the component is at the first value, a radially outer end of the front surface of the impeller hub is caused to be located axially inboard of when the physical dimension of the component is at the second value;
wherein when the physical dimension of each component in the set of components is at the first value, the radially outer end of the front surface of the hub is located at a first axial position and when the physical dimension of each component in the set of components is at the second value, the radially outer end of front surface of the hub is located at a second axial position, the first axial position being located axially inboard of the second axial position;
an annular diffuser recess is provided in the first wall member, the diffuser recess extending radially outwardly from first end to a second end, the first end being located at a radially outer end of the impeller recess, the second end being located axially inboard of the first end of the diffuser recess; and
wherein the depth of the diffuser recess at the first end of the diffuser recess is such that when the radially outer end of the front surface of the hub is at, or between, the first and second axial positions, the radially outer end of the front surface of the hub is located substantially axially in-line with, or inboard of, the first end of the diffuser recess.

19. A turbocharger according to claim 18 wherein the set of components of the turbocharger comprise the impeller wheel and/or the bearing assembly.

20. A turbocharger according to claim 18 wherein the axial distance between the first and second axial positions is in the range 10% to 40% of the maximum depth of the impeller recess.

21. A turbocharger according to claim 18 wherein the depth of the diffuser recess at the first end of the diffuser recess is at least 30% of the maximum depth of the impeller recess.

22. A turbocharger according to claim 18 wherein during use, the axial position of the radially outer end of the front surface of the hub varies between first and second axial limit positions, the first end of the recess having a depth, in the axial direction, such that when the radially outer end of the front surface of the hub is at, or between, the first and second axial limit positions, the radially outer end of the front surface of the hub is located substantially axially in-line with, or inboard of, the first end of the diffuser recess.

23. A turbocharger according to claim 18 wherein the axial distance between the first and second axial limit positions is in the range 19 to 38% of the maximum depth of the impeller recess.

24. A turbocharger comprising:
a compressor and a turbine;
the compressor comprising;
a housing having an axial intake and an annular outlet volute;
an impeller mounted on a shaft for rotation about a shaft axis between the axial intake and the annular outlet volute;
the impeller having a plurality of blades extending from a root to a tip, the roots of the blades being attached to a front surface of a hub of the impeller;
an annular diffuser passage surrounding the impeller, the diffuser passage extending along a diffuser passage axis from a diffuser inlet downstream of said plurality of blades to a diffuser outlet communicating with the annular outlet volute;
the diffuser passage being defined by first and second diffuser surfaces of first and second wall members respectively;
the impeller hub being mounted in an annular impeller recess in the first wall member;
the turbine comprising;
a turbine housing defining an inlet and an outlet, with a turbine wheel rotatably mounted within a chamber disposed between the inlet and outlet, the turbine wheel being drivably coupled to the impeller wheel by the shaft, the shaft being rotatably supported by a bearing assembly;
the turbocharger being arranged such that, in use, the axial position of a radially outer end of the front surface of the impeller hub varies between first and second axial limit positions;
an annular diffuser recess is provided in the first wall member, the diffuser recess extending radially outwardly from first end to a second end, the first end being located at a radially outer end of the impeller recess, the second end being located axially inboard of the first end of the diffuser recess;
wherein the depth of the diffuser recess at the first end of the diffuser is such that when the radially outer end of the front surface of the impeller hub is at, or between, the first and second axial limit positions, the radially outer end of the front surface of the hub is located substantially axially in-line with, or inboard of, the first end of the diffuser recess.

25. A method of use of a turbocharger comprising a compressor and a turbine;
the compressor comprising;
a housing having an axial intake and an annular outlet volute;
an impeller mounted on a shaft for rotation about a shaft axis between the axial intake and the annular outlet volute;
the impeller having a plurality of blades extending from a root to a tip, the roots of the blades being attached to a front surface of a hub of the impeller;
an annular diffuser passage surrounding the impeller, the diffuser passage extending along a diffuser passage axis from a diffuser inlet downstream of said plurality of blades to a diffuser outlet communicating with the annular outlet volute;
the diffuser passage being defined by first and second diffuser surfaces of first and second wall members respectively;
the impeller hub being mounted in an annular impeller recess in the first wall member;
the turbine comprising;
a turbine housing defining an inlet and an outlet, with a turbine wheel rotatably mounted within a chamber disposed between the inlet and outlet, the turbine wheel being drivably coupled to the impeller wheel by a shaft rotatably supported by a bearing assembly;
an annular diffuser recess is provided in the first wall member, the diffuser recess extending radially outwardly from first end to a second end, the first end being located at a radially outer end of the impeller recess, the second end being located axially inboard of the first end of the diffuser recess;
wherein, in use, the axial position of a radially outer end of the front surface of the impeller hub varies between first and second axial limit positions; and
wherein the depth of the diffuser recess at the first end of the diffuser is such that when the radially outer end of the front surface of the hub is at, or between, the first and second axial limit positions, the radially outer end of the front surface of the hub is located substantially axially in-line with, or inboard of, the first end of the diffuser recess.
